(19) United States
(12) Patent Application Publication
(10) Pub. No.: US 2023/0249010 A1
(43) Pub. Date: Aug. 10, 2023

(54) MASK AND MANUFACTURING METHOD THEREOF

(71) Applicant: SAMHWAN TF CO., LTD., Seoul (KR)

(72) Inventors: Byung Hwan TAK, Seoul (KR); Yu Jin AHN, Pocheon-si, Gyeonggi-do (KR)

(21) Appl. No.: 18/005,262

(22) PCT Filed: Jul. 21, 2021
(86) PCT No.: PCT/KR2021/008630

§ 371 Date: Jan. 12, 2023

(30) Foreign Application Priority Data
Aug. 18, 2020 (KR) 10-2020-010295
Jun. 2, 2021 (KR) 10-2021-007172

(51) Int. Cl. A62B 18/02; A41D 13/11; A41D 31/102; B01D 39/16

(52) U.S. Cl. CPC A62B 18/02; A41D 13/1161; A41D 31/102; B01D 39/163; A41D 2500/30; B01D 2239/0631; B01D 2239/0654; B01D 2239/0672; B01D 2239/10; B01D 2239/1291

(57) ABSTRACT

The present invention relates to a mask comprising a mask body for covering a wearer's face and wearing straps coupled to both sides of the mask body, the mask body comprising a filter member having: a support layer having a mesh structure; and a filter coating layer formed on the outer surface of the support layer and for filtering contaminants, wherein the filter coating layer is formed from a microfiber web eletrospinned on the support layer.

### TECHNICAL FIELD

The present disclosure relates to a mask and a method of manufacturing the same, and more particularly, to a mask and a method of manufacturing the same in which a filter member constituting a mask body is configured in a form in which a very thin filter layer is coated on a surface of a support layer having a mesh structure, thus facilitating breathing for a wearer and having excellent filtering efficiency against contaminants or bacteria.

### BACKGROUND ART

Masks are intended to prevent contaminants harmful to the human body such as dust, pollen, particulate matter, and pathogenic bacteria contained in the air from being inhaled into the human respiratory system. In general, a mask consists of a mask body configured to cover a wearer's face and loop-shaped straps coupled to both left and right ends of the mask body and configured to be hung on ears of the wearer.

Conventional masks are mostly made of cotton. Such cotton masks prevent direct inhalation of cold air through the nasal or oral cavity and thus can prevent colds or the like. However, due to the nature of a plain-weave cotton fabric with loose threads, there is a problem that it is not effective in blocking harmful substances with a very small size, such as viruses, bacteria, and particulate matter, smaller than pores formed between the threads of the cotton fabric.

Thus, in recent years, demand for health/disinfection masks with improved filtering performance by mixing nonwoven fabrics, filters, and the like to block yellow dust, particulate matter, fine particulate matter, pathogenic bacteria, viruses, and the like has rapidly increased. Details of such health/disinfection masks are disclosed in the following [Document 1] or the like.

Typical examples of the health/disinfection masks include Korea Filter (KF)80 and KF94 masks using melt blown nonwoven filters. In most of these health/disinfection masks, a mask body is formed by stacking electrostatic fibers to a certain thickness (0.15 to 0.25 mm) to maintain an outer shape of the mask body and filter contaminants.

Accordingly, the conventional health/disinfection masks are configured so that fine contaminants contained in the air are adsorbed by the above-mentioned static electricity when air passes through the mask body. In this case, since the air that the wearer breathes has to pass through the thickness of the mask, there is a problem that, when the mask is worn for a long time, the wearer's breathing becomes uncomfortable due to an increase in inhalation resistance.

Also, since the conventional health/disinfection masks use a method of adsorbing contaminants by static electricity, blocking efficiency against fine contaminants is excellent in everyday life. However, there is a problem that, in a case in which the mask is worn in an environment exposed to moisture, such as a swimming pool or water park or on a rainy day, when the mask body gets wet and the static electricity of the nonwoven filters is lost, the filtering function against contaminants does not work properly, and thus it is not possible to block pathogenic bacteria, such as severe acute respiratory syndrome (SARS) or coronavirus, which spread through respiratory droplets of infected people.

In addition, since the conventional health/disinfection masks require electrostatic fibers to be stacked to a certain thickness as described above, there is a problem that, when the mask is worn at a swimming pool or water park and the mask body gets wet, water particles that permeate into the entire nonwoven fabric block fine pores of the mask body, which makes it more difficult for the wearer to breathe.

[Document 1] Korean Patent Publication No. 2011-0046906 (Date of Publication: May 6, 2011)

### DISCLOSURE

### Technical Problem

The present disclosure is directed to providing a mask and a method of manufacturing the same in which a thickness of a mask body is made very thin to facilitate breathing for a wearer and have excellent filtering efficiency against contaminants or bacteria.

The present disclosure is also directed to providing a mask and a method of manufacturing the same in which, even when a mask body is wet, water drainage is excellent so that it is easy for a wearer to breathe, and filtering efficiency against contaminants or bacteria is maintained at almost the same level as before the mask body gets wet, thus allowing the mask to be worn continuously even in an environment exposed to moisture, such as on a rainy day or while playing in water, and preventing infection with pathogenic bacteria or viruses that can spread through respiratory droplets of infected people.

### Technical Solution

The present disclosure provides a mask including a mask body configured to cover a wearer's face and wearing straps coupled to both sides of the mask body, wherein the mask body includes a filter member that consists of a support layer having a mesh structure and a filter coating layer formed on one side surface of the support layer to filter contaminants, and the filter coating layer is made of a web of fine fibers electrospun on the support layer.

Also, the filter coating layer may include a first filter coating layer made of a web of first fine fibers electrospun on the one side surface of the support layer and a second filter coating layer made of a web of second fine fibers electrospun on a surface of the first filter coating layer, and a diameter of the second fine fibers may be less than a diameter of the first fine fibers.

Also, the support layer and the filter coating layer may be made of a polyester (PET) material.

Also, the support layer may be made by weaving polyester yarn having a thickness of 5 to 50 denier into 100 to 150 mesh.

Also, a thickness of the first fine fibers may be 10 to 40 μm, and a thickness of the second fine fibers may be 0.05 to 2 μm.

Also, at least any one of the support layer and the filter coating layer may include at least any one of a graphene component and a linolenic acid component.

Also, the mask body may further include a face contact member which is coupled to the other side surface of the support layer and has a plurality of through-holes formed therein.

Also, the face contact member may be a nonwoven fabric made of a water-repellent polypropylene (PP) material.

Also, a bonding portion where the filter member and the face contact member are bonded to each other by ultrasonic welding may be formed on an outer surface of the mask body, and the bonding portion may include a first bonding portion where the filter member and the face contact member are bonded to each other along edge portions thereof to form the mask body and a second bonding portion where the filter member and the face contact member are bonded to each other at a central portion of the mask body to serve as a rib that prevents the mask body from coming in close contact with the wearer's face.

In addition, a method of manufacturing a mask according to the present disclosure includes weaving yarn into a mesh structure to form a support layer, forming a first filter coating layer made of a web of first fine fibers on one side surface of the support layer by electrospinning, forming a second filter coating layer made of a web of second fine fibers on a surface of the first filter coating layer by electrospinning, and coupling a face contact member to the other side surface of the support layer on which the first and second filter coating layers are formed, wherein a diameter of the second fine fibers is less than a diameter of the first fine fibers, and a plurality of through-holes are formed in the face contact member.

### Advantageous Effects

In a mask according to the present disclosure, a filter member constituting a mask body consists of a support layer having a mesh structure and a filter coating layer having a thin thickness and formed on a surface of the support layer. In this way, since a length of an air inhalation path through fine pores (that corresponds to the thickness of the filter coating layer) is remarkably short, there is an advantage in that it is very easy for a wearer to breathe because inhalation resistance is low while filtering efficiency against contaminants (pollen, particulate matter, pathogenic bacteria, viruses, and the like) is at the same excellent level as compared to conventional health/disinfection masks made of a thick nonwoven fabric material.

Also, since the mask according to the present disclosure filters contaminants through fine pores formed in the filter coating layer without using an electrostatic attractive force, there is an advantage in that, even when the filter member gets wet in an environment exposed to moisture such as on a rainy day or in a swimming pool or water park, filtering efficiency against contaminants can be maintained at almost the same level as before the filter member gets wet.

In addition, in the mask according to the present disclosure, even when the filter member gets wet in the environment exposed to moisture, most of the water passing through the thin filter coating layer exits through a network of the support layer, and the fine pores of the filter member are not blocked. Thus, there is an advantage in that, since it is easy for a wearer to breathe and the mask can be worn continuously, infection with pathogenic bacteria or viruses that can spread through respiratory droplets of infected people can be very efficiently prevented.

### DESCRIPTION OF DRAWINGS

FIGS. 1 and 2 are perspective views of the front and back of a mask according to one embodiment of the present disclosure.

FIG. 3 is a cross-sectional view taken along line A-A of FIG. 1.

FIGS. 4A and 4B are views showing microstructures of first and second filter coating layers illustrated in FIG. 3 and scanning electron microscope (SEM) pictures thereof.

FIG. 5 is a flowchart for describing a method of manufacturing the mask according to one embodiment of the present disclosure.

FIGS. 6A and 6B are views showing performance (dust filtration efficiency, facial inhalation resistance) test results of the mask according to one embodiment of the present disclosure.

FIGS. 7A, 7B and 8 are views showing performance (bacterial filtration efficiency) test results of the mask according to one embodiment of the present disclosure and a copy of a test report relating to the results.

### MODES OF THE INVENTION

Hereinafter, exemplary embodiments of the present disclosure will be described in detail with reference to the accompanying drawings.

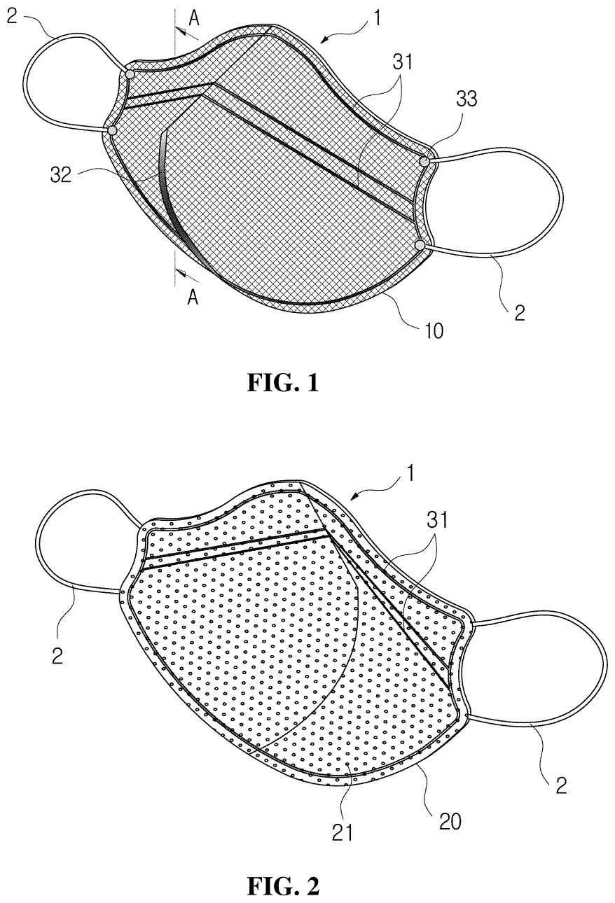

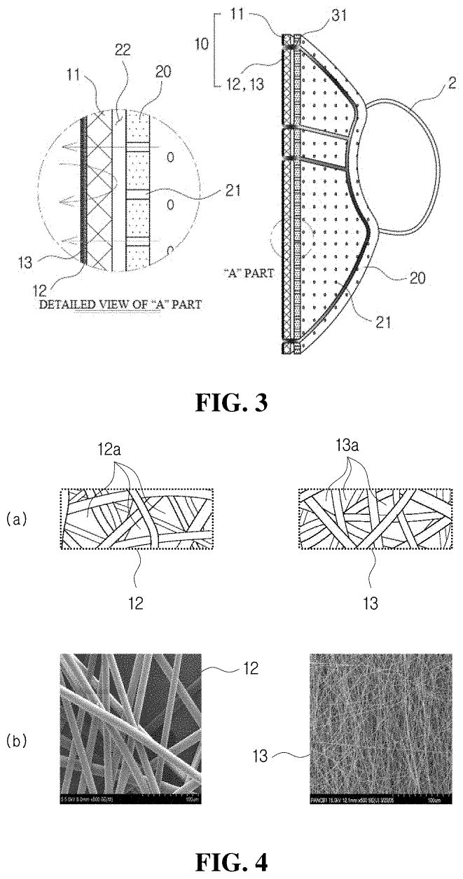

FIGS. 1 and 2 are perspective views of the front and back of a mask according to one embodiment of the present disclosure, and FIG. 3 is a cross-sectional view taken along line A-A of FIG. 1.

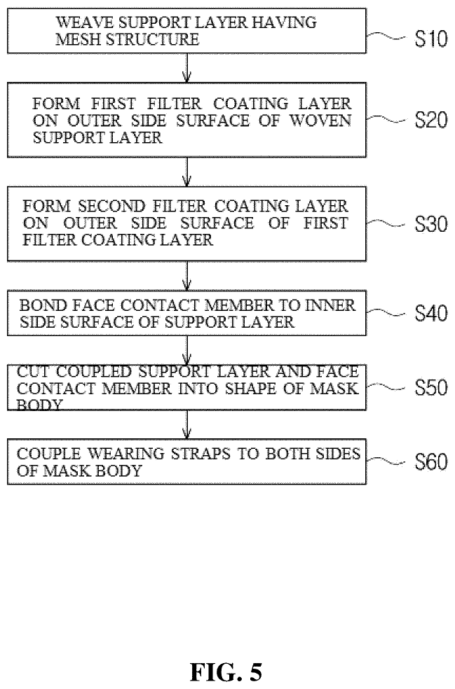

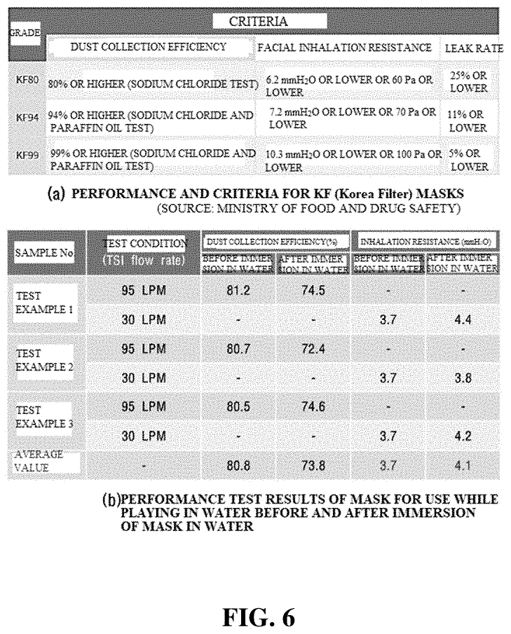

Also, FIGS. 4A and 4B are views showing microstructures of first and second filter coating layers illustrated in FIG. 3 and scanning electron microscope (SEM) pictures thereof, and FIG. 5 is a flowchart for describing a method of manufacturing the mask according to one embodiment of the present disclosure.

The mask according to one embodiment of the present disclosure includes a mask body 1 configured to cover a wearer's face and wearing straps 2 coupled to both sides of the mask body 1.

Also, the mask body 1 includes a filter member 10 configured to filter contaminants. The term “contaminants” in the detailed description and the claims of this specification is a concept encompassing pollen, particulate matter, fine particulate matter, pathogenic bacteria or viruses, and respiratory droplets containing the pathogenic bacteria or viruses.

Also, the filter member 10 includes a support layer 11 having a mesh structure and filter coating layers 12 and 13 formed on one side surface (that is, an outer surface or inner surface) of the support layer 11 to filter contaminants. In the present embodiment, as an example, the filter coating layers 12 and 13 are formed on the outer surface of the support layer 11.

Here, the support layer 11 is for maintaining the shape of the mask body 1 or filter member 10 and is made of a mesh structure (that is, a network structure) with excellent air flow or water drainage. In the present disclosure, any one of known polymeric resin fiber yarns is woven to form the mesh structure.

To this end, in the present embodiment, as an example, the support layer 11 is made by weaving polyester (PET) yarn into a mesh structure. Specifically, the support layer 11 is made by weaving polyester yarn having a thickness of 5 to 50 denier into 100 to 150 mesh.

Also, the filter coating layers 12 and 13 are for serving as filters that filter fine contaminants. In the present disclosure, the filter coating layers 12 and 13 are made of a web of fine fibers obtained by electrospinning of a molten polymeric resin solution (that is, a spinning solution) on the outer surface of the support layer 11. Since the details of the electrospinning are known technology, a detailed description thereof will be omitted herein.

In this way, in the mask according to the present disclosure, the support layer 11 with excellent air flow or water drainage maintains the shape of the mask body 1 or filter member 10, and the filter coating layers 12 and 13 formed on the outer surface of the support layer 11 are configured to substantially serve only as filters that filter contaminants.

Accordingly, it is sufficient when the filter coating layers 12 and 13 are stacked (or coated) on the outer surface of the support layer 11 with a thickness necessary to form a web for filtering contaminants. In the present embodiment, as an example, the filter coating layers 12 and 13 are formed with a thickness of about 10 to 500 μm.

Therefore, as compared to the thickness (0.15 to 0.25 mm) of the melt blown nonwoven filters used in the conventional health/disinfection masks, the thickness (10 to 500 μm) of the fibrous web (that is, the filter coating layers) substantially forming a filter portion that filters contaminants is remarkably reduced to the level of a coating film in the mask according to the present disclosure.

As a result, in the mask according to the present disclosure, a length of an air path through fine pores (which will be described below) formed in the filter coating layers 12 and 13 (that is, a length corresponding to the thickness of the filter coating layers) during breathing is very short. Thus, there is an advantage in that, when compared to the health/disinfection masks made of the conventional nonwoven filters in which a length of an air path (that is, a length corresponding to the thickness of the nonwoven filters) is relatively long, facial inhalation resistance is significantly reduced, which is the major function of the mask.

Accordingly, when the mask according to the present disclosure is used as a mask for blocking pollen or a mask for blocking particulate matter, there is an effect of significantly facilitating breathing for a wearer while filtering efficiency against contaminants is at the same excellent level as compared to the conventional health/disinfection masks.

Also, since the filter coating layers 12 and 13 in the mask according to the present disclosure do not have a thickness sufficient to store water, in a case in which the mask is worn in an environment exposed to moisture such as on a rainy day or in a swimming pool or water park, even when the filter member 10 gets wet, most of the water passing through the filter coating layers 12 and 13 exits through the network of the support layer 11 without permeating into the filter coating layers 12 and 13 or stagnating in the fine pores formed in the filter coating layers 12 and 13 as will be described below.

Accordingly, in the mask according to the present disclosure, even when the mask body 1 is wet, water drainage is excellent, and fine pores of the filter member 10 which will be described below (specifically, the fine pores of the filter coating layers) are not blocked. Thus, there are advantages in that it is easy for the wearer to breathe, and the mask can be worn continuously even in an environment exposed to moisture.

Meanwhile, in the mask according to the present disclosure, the filter coating layers 12 and 13 may be formed as a single coating layer, but the filter coating layers 12 and 13 may also be formed as a plurality of coating layers as necessary in order to improve filtering efficiency against contaminants.

To this end, in the present embodiment, as an example, the filter coating layers 12 and 13 include a first filter coating layer 12 made of a web of first fine fibers (not illustrated) electrospun on the outer surface of the support layer 11 and a second filter coating layer 13 made of a web of second fine fibers (not illustrated) electrospun on an outer surface of the first filter coating layer 12.

Here, the first filter coating layer 12 is directly electrospun on the outer surface of the support layer 11 and forms first fine pores 12a which are macropores having a relatively large size, and the second filter coating layer 13 is electrospun on the outer surface of the first filter coating layer 12, divides the first fine pores 12a, and forms second fine pores 13a which are micropores having a relatively small size.

To this end, in the electrospinning operation described above, a diameter of the second fine fibers forming the second filter coating layer 13 may be adjusted to be less than a diameter of the first fine fibers forming the first filter coating layer 12.

In the present embodiment, as an example, the filter coating layers 12 and 13 are made of the same polyester material as the polyester material of the support layer 11 in consideration of adhesion to the support layer 11, but the present disclosure is not limited thereto, and of course, the filter coating layers 12 and 13 may be made of a polymeric resin material different from the material of the support layer 11 as necessary.

Also, in the present embodiment, as an example, a thickness of the first fine fibers is 10 to 40 μm, and a thickness of the second fine fibers is 0.05 to 2 μm.

The filter member 10 of the mask according to the present disclosure configured as described above filters contaminants using the first and second fine pores 12a and 13a formed in the filter coating layers 12 and 13 instead of adsorbing contaminants using an electrostatic attractive force or repulsive force like the conventional health/disinfection masks made of nonwoven filters (that is, KF80 or KF94 masks). Thus, there are advantages in that it is not necessary to perform electrostatic treatment when manufacturing the filter member 10, and costs for manufacturing the mask can be reduced.

Also, the conventional health/disinfection masks made of nonwoven filters have a disadvantage in that, when the masks get wet in an environment exposed to moisture, the masks lose static electricity, and the efficiency of filtering particulate matter and filtering bacteria, which are major functions of the health/disinfection masks, is greatly lowered.

On the other hand, in the mask according to the present disclosure, even when the mask body 1 gets wet, the efficiency of filtering particulate matter and filtering bacteria by the filter member 10 can be maintained at almost the same level as before the mask body 1 gets wet. Thus, there is an advantage in that it is possible to efficiently block infectious bacteria such as severe acute respiratory syndrome (SARS) or coronavirus, which may spread through respiratory droplets of infected people.

Meanwhile, in a case in which the filter coating layers 12 and 13 are formed on the outer surface of the support layer 11 as in the present embodiment, since an inner surface of the support layer 11 that comes in contact with the wearer's face has a mesh structure, the mask according to the present disclosure may be uncomfortable to wear due to the rough texture of the mesh.

Accordingly, in order to prevent the above wearing discomfort, as an example, the mask according to the present embodiment is configured so that the mask body 1 further includes a face contact member 20 coupled to the other side surface of the support layer 11 (in the case of the present embodiment, the inner surface of the support layer). However, of course, the configuration of the face contact member 20 may be omitted as necessary (for example, to block particulate matter or to block pollen).

Also, in a case in which water enters between the mask body 1 and the wearer's face through an edge portion of the mask body 1 that comes in contact with the wearer's face or through the face contact member 20 from the front of the mask body 1 in an environment exposed to moisture (in particular, while playing in water), in order to allow the entering water to be discharged toward the filter member 10, a plurality of drain holes 21 may be formed in the shape of through-holes in the face contact member 20.

Here, in addition to performing the above-described drainage function, the drain holes 21 minimize breathing resistance due to the face contact member 20, thus also performing a function of preventing an increase in facial inhalation resistance, which is one major function of health/disinfection masks.

Also, the face contact member 20 may be made of a water repellent material to minimize the entry of water between the mask body 1 and the wearer's face through the face contact member 20 from the front of the mask body 1 in an environment exposed to moisture (in particular, while playing in water). To this end, in the present embodiment, the face contact member 20 is made of a nonwoven fabric formed of a polypropylene (PP) material which is a water-repellent polymeric resin.

Also, bonding portions 31, 32, and 33 where the filter member 10 and the face contact member 20 are bonded to each other by ultrasonic welding are formed on an outer surface of the mask body 1. The bonding portions 31, 32, and 33 include a first bonding portion 31 where the filter member 10 and the face contact member 20 are bonded to each other along edge portions thereof, a second bonding portion 32 where the filter member 10 and the face contact member 20 are bonded to each other at a central portion of the mask body 1, and a third bonding portion 33 where an end portion of the wearing strap 2 is bonded to one side of the outer surface of the mask body 1.

Here, in the first bonding portion 31, the edge portions of the filter member 10 and the face contact member 20 are bonded to each other to form the mask body 1. In the present embodiment, as an example, the first bonding portion 31 is formed not only on the above-mentioned edge portions but also in a width direction (that is, the left-right direction) of the filter member 10 and the face contact member 20 to prevent excessive relative displacement between the filter member 10 and the face contact member 20.

Also, in the second bonding portion 32, the filter member 10 and the face contact member 20 are bonded to each other in a longitudinal direction (that is, the up-down direction) at the central portion of the mask body 1. The second bonding portion 32 serves as a rib that prevents the mask body 1 from coming in close contact with the wearer's face.

To this end, in the present embodiment, as an example, the second bonding portion 32 is formed to protrude in the direction of the outer surface of the mask body 1.

Also, between the filter member 10 and the face contact member 20 coupled to each other as described above, a gap 22 where the filter member 10 and the face contact member 20 are spaced apart from each other is formed in areas excluding the bonding portions 31, 32, and 33. Due to the gap 22, most of the water entering from the filter member 10 in the direction of the face contact member 20 is discharged to the outside through the mesh of the support layer 11 where flow resistance is relatively lower as compared to the drain holes 21. In this way, entry of water toward the wearer's face in an environment exposed to moisture (in particular, while playing in water) can be further prevented.

Meanwhile, in the present embodiment, as an example, a case in which the filter member 10 consists of the support layer 11 and the filter coating layers 12 and 13 formed on the outer surface of the support layer 11 has been described. However, the present disclosure is not limited thereto, and the filter member 10 may, as necessary, further include a cover layer (not illustrated) formed on an outer surface of the filter coating layers 12 and 13 and having a mesh structure similar to the mesh structure of the support layer 11.

Also, a material of at least any one of the support layer 11, the first and second filter coating layers 12 and 13, and the face contact member 20 may contain a functional component. In the present embodiment, as an example, at least any one of a graphene component and a linolenic acid component is used as the functional component.

The graphene component has excellent electrical conductivity (100 times higher than that of copper) and thus lowers electrical resistivity of the surface of the mask body 1 and promptly releases the generated static charge. In this way, the graphene component allows obtaining a static electricity blocking effect.

Also, the graphene component has an antibacterial function of removing bacteria such as Escherichia coli and Staphylococcus aureus and has excellent elasticity. Thus, the graphene component allows an effect of maintaining the antibacterial property of the surface of the mask body 1 and an effect of imparting elasticity so that the mask body 1 can be easily deformed according to various facial curves of wearers to be obtained.

Also, the linolenic acid component is contained in plant oils extracted from flaxseeds, sunflower seeds, chia seeds, and the like. Since the linolenic acid component has an ultraviolet (UV) blocking function and an antibacterial function, an effect of protecting the skin can be obtained, and due to the linolenic acid component's function of allowing a large amount of far infrared rays to be radiated, an effect of increasing cellular vitality can be obtained.

In addition, the linolenic acid component has sweat-absorbing, quick-drying, and deodorizing functions, and thus it is possible to obtain an effect of maintaining a pleasant wearing sensation through removal of bad breath and removal of moisture even when the mask is worn for a long time.

Next, a method of manufacturing the mask according to the present disclosure configured as described above will be described using FIG. 5.

First, the support layer 11 having the mesh structure is woven using polyester yarn as described above (S10), and then, the first filter coating layer 12 made of the web of the first fine fibers is formed on the outer surface of the woven support layer 11 by electrospinning (S20).

When operation S20 is completed, the second filter coating layer 13 made of the web of the second fine fibers is formed on the outer surface of the first filter coating layer 12 by electrospinning (S30). Here, as described above, the diameter of the second fine fibers may be less than the diameter of the first fine fibers.

When operation S30 is completed, the face contact member 20 in which the plurality of drain holes 21 are formed is coupled to the inner surface of the support layer 11 on which the first and second filter coating layers 12 and 13 are formed (S40). The coupling is performed by ultrasonic welding at the first and second bonding portions 31 and 32 as described above.

Also, the drain holes 21 of the face contact member 20 made of a nonwoven fabric as described above may be formed by typical laser perforation.

Also, when operation S40 is completed, the coupled support layer 11 and face contact member 20 are cut into the shape of a mask to form the mask body 1 (S50), and then, the wearing straps 2 are coupled to both sides of the mask body 1 (S60).

Here, in a case in which the configuration of the face contact member 20 is not included, operation S40 is omitted, and in operation S50, the mask body 1 is formed using the filter member 10 that consists of the support layer 11 and the filter coating layers 12 and 13.

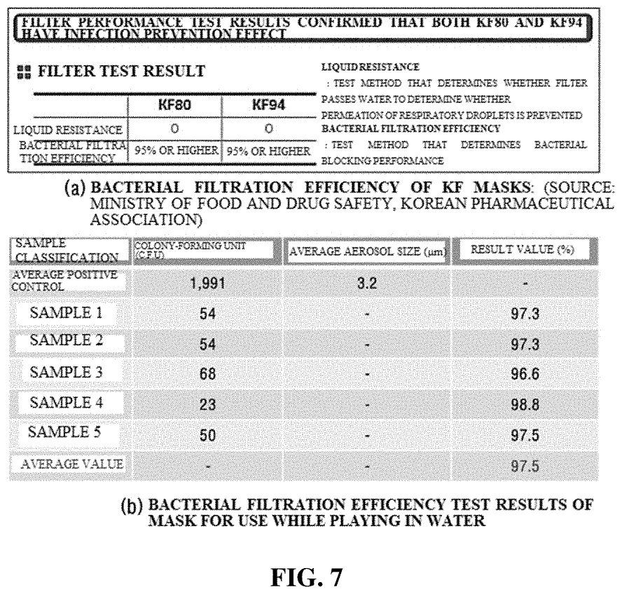

In order to evaluate the performance of the mask according to the present disclosure configured as described above, in accordance with the standard test specifications for domestic and foreign health/disinfection masks, tests were conducted on three items: dust collection efficiency, facial inhalation resistance, and bacterial filtration efficiency, and results of the tests are shown in FIGS. 6A to 8.

First, FIGS. 6A and 6B are views showing performance (dust filtration efficiency, facial inhalation resistance) test results of the mask according to one embodiment of the present disclosure. FIG. 6A shows dust collection efficiency (%) and facial inhalation resistance (mmH₂O) test results for KF health/disinfection masks, and FIG. 6B shows test results of measuring dust collection efficiency and facial inhalation resistance before and after immersion of the mask body 1 in water for the mask according to the present embodiment.

The tests were conducted using a TSI 8130 tester in accordance with BS EN 143, the European standard applied in South Korea for health masks, and NaCl was used as an aerosol (a flow rate of 95 LPM was applied for dust collection efficiency, and a flow rate of 30 LPM was applied for facial inhalation resistance).

As a result of the dust collection efficiency test for the mask according to the present disclosure, the average dust collection efficiency before immersion of the mask body 1 in water was 80.8% (number of samples: 3) and was evaluated to be similar to the dust collection efficiency of KF80 masks, and the average dust collection efficiency after immersion of the mask body 1 in water was 73.8% (number of samples: 3) and was not found to be significantly lower than before immersion of the mask body 1 in water. In this way, it was confirmed that contaminant filtration performance of the mask according to the present disclosure can still be maintained high even when the mask gets wet in an environment exposed to moisture.

Also, in the case of facial inhalation resistance which indicates the ease of breathing while wearing a mask, the average facial inhalation resistance before immersion of the mask body 1 in water was 3.7 mmH₂O (number of samples: 3), and the average facial inhalation resistance after immersion of the mask body 1 in water was 4.1 mmH₂O (number of samples: 3). In both cases, the average facial inhalation resistance was evaluated as meeting the KF mask performance standards. In this way, it was confirmed that, even when the mask according to the present disclosure is worn continuously in an environment exposed to moisture (in particular, while playing in water) as well as in everyday life, water drainage performance is excellent, and the wearer can easy breathe.

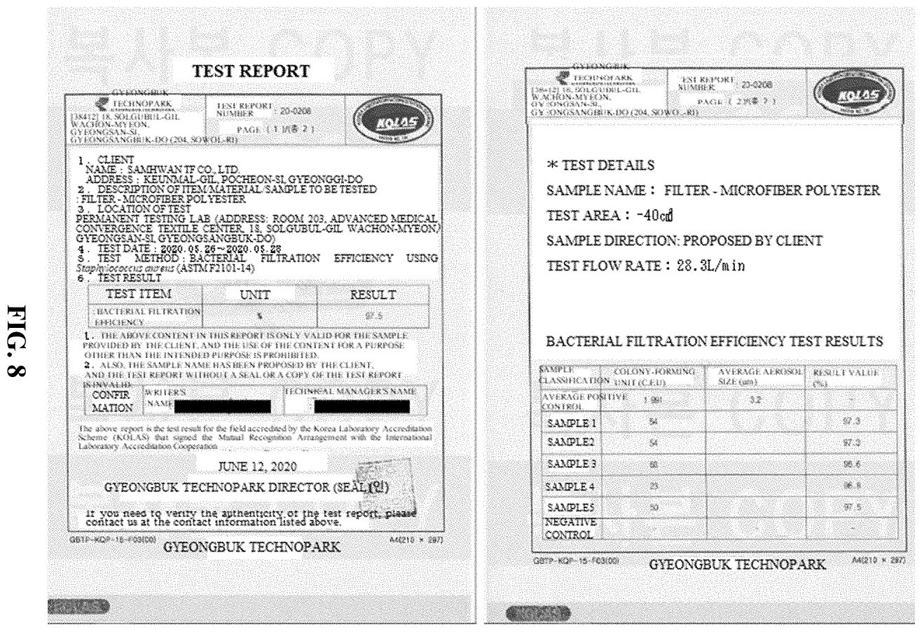

Next, FIGS. 7A, 7B and 8 are views showing performance (bacterial filtration efficiency) test results of the mask according to one embodiment of the present disclosure and a copy of a test report relating to the results. FIG. 7A shows bacterial filtration efficiency test results of domestic KF masks by the Korean Pharmaceutical Association, and FIG. 7B shows bacterial filtration efficiency test results of the mask according to the present disclosure.

The test was conducted at Gyeongbuk TechnoPark, a domestic accredited mask testing institute, in accordance with ASTM F2101-14, a standard test method for bacterial filtration efficiency of medical masks (Staphylococcus aureus, a test flow rate of 28.3 LPM, and an average aerosol size of 3.2 μm were applied).

As bacterial filtration efficiency test results of the mask according to the present disclosure, the average bacterial filtration efficiency was 97.5% (number of samples: 5) and was evaluated to be the same as or higher than the bacterial filtration efficiency of KF94 masks. Considering that the mask according to the present disclosure filters contaminants using fine pores instead of using static electricity, the bacterial filtration efficiency is expected to be the same or higher even when the mask is wet.

Accordingly, it was confirmed that the mask according to the present disclosure can very efficiency prevent infection with pathogenic bacteria or viruses that can spread through respiratory droplets of infected people, even in an environment exposed to moisture (in particular, in a swimming pool or water park).

### INDUSTRIAL APPLICABILITY

The mask according to the present disclosure can be utilized as a mask for blocking particulate matter, a mask for blocking pollen, or a health/disinfection mask exclusively for use in a swimming pool or water park.

1. A mask comprising:
a mask body configured to cover a wearer's face; and
wearing straps coupled to both sides of the mask body,
wherein the mask body includes a filter member that consists of a support layer having a mesh structure and a filter coating layer formed on one side surface of the support layer to filter contaminants, and
the filter coating layer is made of a web of fine fibers electrospun on the support layer.

2. The mask of claim 1, wherein:
the filter coating layer includes a first filter coating layer made of a web of first fine fibers electrospun on the one side surface of the support layer and a second filter coating layer made of a web of second fine fibers electrospun on a surface of the first filter coating layer; and
a diameter of the second fine fibers is less than a diameter of the first fine fibers.

3. The mask of claim 2, wherein the support layer and the filter coating layer are made of a polyester (PET) material.

4. The mask of claim 3, wherein the support layer is made by weaving polyester yarn having a thickness of 5 to 50 denier into 100 to 150 mesh.

5. The mask of claim 2, wherein a thickness of the first fine fibers is 10 to 40 μm, and a thickness of the second fine fibers is 0.05 to 2 μm.

6. The mask of any one of claims 1 to 5, wherein at least any one of the support layer and the filter coating layer includes at least any one of a graphene component and a linolenic acid component.

7. The mask of any one of claims 1 to 5, wherein the mask body further includes a face contact member which is coupled to the other side surface of the support layer and has a plurality of through-holes formed therein.

8. The mask of claim 7, wherein the face contact member is a nonwoven fabric made of a water-repellent polypropylene (PP) material.

9. The mask of claim 8, wherein:
a bonding portion where the filter member and the face contact member are bonded to each other by ultrasonic welding is formed on an outer surface of the mask body; and
the bonding portion includes a first bonding portion where the filter member and the face contact member are bonded to each other along edge portions thereof to form the mask body and a second bonding portion where the filter member and the face contact member are bonded to each other at a central portion of the mask body to serve as a rib that prevents the mask body from coming in close contact with the wearer's face.

10. The mask of claim 7, wherein the face contact member includes at least any one of a graphene component and a linolenic acid component.

11. A method of manufacturing a mask, the method comprising:
weaving yarn into a mesh structure to form a support layer;
forming a first filter coating layer made of a web of first fine fibers on one side surface of the support layer by electrospinning;
forming a second filter coating layer made of a web of second fine fibers on a surface of the first filter coating layer by electrospinning; and
coupling a face contact member to the other side surface of the support layer on which the first and second filter coating layers are formed,
wherein a diameter of the second fine fibers is less than a diameter of the first fine fibers, and
a plurality of through-holes are formed in the face contact member.

12. The method of claim 11, wherein:
the support layer and the first and second filter coating layers are made of a polyester material; and
the face contact member is a nonwoven fabric made of a water-repellent polypropylene material.

13. A method of manufacturing a mask, the method comprising:
using yarn to form a support layer having a mesh structure;
forming a first filter coating layer made of a web of first fine fibers on one side surface of the support layer by electrospinning; and
forming a second filter coating layer made of a web of second fine fibers on a surface of the first filter coating layer by electrospinning,
wherein a diameter of the second fine fibers is less than a diameter of the first fine fibers.
